(19) United States
(12) Patent Application Publication
(10) Pub. No.: US 2006/0234186 A1
(43) Pub. Date: Oct. 19, 2006

(54) Bearing for dental handpiece

(76) Inventors: Eugene J. Novak, Deerfield, IL (US); Tom Papanek, Lake Forest, IL (US); Mikhail Ayzenshetyn, Buffalo Grove, IL (US)

Correspondence Address: DENTSPLY INTERNATIONAL INC, 570 WEST COLLEGE AVENUE, YORK, PA, 17404, US

(21) Appl. No.: 11/455,015

(22) Filed: Jun. 16, 2006

Related U.S. Application Data
(63) Continuation-in-part of application No. 11/444,890, filed on May 31, 2006.
Application No. 11/444,890 is a continuation-in-part of application No. 10/353,714, filed on Jan. 29, 2003, now abandoned.
Application No. 10/353,714 is a continuation of application No. 10/082,580, filed on Feb. 25, 2002, now abandoned.
Application No. 10/082,580 is a continuation-in-part of application No. 09/951,062, filed on Sep. 13, 2001, now abandoned.
(60) Provisional application No. 60/232,256, filed on Sep. 14, 2000.

(51) Int. Cl. A61C 1/00

(52) U.S. Cl. 433/131

(57) ABSTRACT

A dental handpiece (10) has a supporting rotor assembly (15) and ball bearings (13, 14) supporting the rotor. Each ball bearing (13, 14) has a plurality of balls (22). Each bearing (13, 14) has an inner race (20) and an outer race (21) and at least the outer race (21) has an increased outer diameter.

### RELATED APPLICATIONS

This patent application is a Continuation-In-Part of pending U.S. patent application Ser. No. 11/444,890 filed on May 31, 2006, which is Continuation-In-Part of pending U.S. patent application Ser. No. 10/353,714 filed on Jan. 29, 2003 which is a Continuation of Abandoned U.S. patent application Ser. No. 10/082,580 filed on Feb. 25, 2002 which is a Continuation-In-Part of abandoned U.S. patent application Ser. No. 09/951,062 filed on Sep. 13, 2001 which was filed from expired U.S. Provisional Patent Application No. 60/232,256 filed on Sep. 14, 2000.

### TECHNICAL FIELD

The present invention is directed toward dental handpieces. More particularly, the invention is directed toward a dental handpiece having an improved bearing construction. The inventive bearing has a thick outer race and/or inner race.

### BACKGROUND OF THE INVENTION

Audible sound levels in air-turbine dental high-speed handpieces are currently known to range as high as 65-78 dBA or sometimes higher. This noise level is a primary complaint of users. Furthermore, there is a peak in the sound spectra at about 7,000 Hz, corresponding to the rotation speed of 425,000 rpm, and characterized by users as a “high pitched whine”. It is clearly desirable to reduce the sound emitted by dental handpieces. It is believed that the bearing is one of the sources of this noise. For example, the Gyro handpiece available from Bien Air, has an air bearing and is known to have a lower sound intensity at 7,000 Hz. The bearing is typically the first element to fail (wear-out) in a dental handpiece.

The inner and outer races of bearings commonly used in dental handpieces today have thin cross sections which make it difficult to fabricate (grind) the bearing races to the desired precision (often required to be 10×10-6 inches roundness and concentricity) and surface finish (often required to be 4×10-6 inches RMS or better.) Any improvements in bearing precision and surface finish are expected to improve bearing life and reduce bearing noise, and are therefore desirable.

The inner races of bearings used in dental handpieces today have thin cross sections which make it difficult to press the bearings onto the shaft (bur-tube) without distortion. Any distortion of the inner race will result in variable clearances and forces on the balls, increasing noise and decreasing life.

Almost all bearings used in dental handpieces today have inner race ID (bore) of 0.125″. The standard diameter of bur shanks commonly used in a high-speed handpieces is 0.063″. This leaves an annular ring of only 0.031″ inch thickness in which to construct the chucking mechanism and bearing support shaft (bur-tube). This material limit constrains optimal design of the chuck and adequate stiffness of the bur-tube. For example, if the bur-tube distorts, it will cause the bearing inner race to distort. If the chuck is too thin, it may not adequately grip the bur.

Dental handpieces of any type or design are useful in conjunction with the bearings according to the present invention. One particularly useful class of such handpieces are conventionally known as “high speed” handpieces, and are often air-driven. Examples of such handpieces are shown for example, in U.S. Pat. Nos. 4,089,115, 4,279,597 and 5,040,980, which are hereby incorporated by reference for such disclosure.

### SUMMARY OF THE INVENTION

It is therefore, an object of the invention to provide a dental handpiece.

It is another object of the invention to provide a dental handpiece improved with respect to its bearing construction.

It is a further object of the invention to provide a bearing construction for a dental handpiece which improves the audible sound qualities of the handpiece.

These and other objects of the invention which will become apparent from the following discussion, are accomplished by the invention as hereinafter described and claimed.

In general a dental handpiece comprises a rotor and a ball bearing assembly supporting said rotor. Said ball bearing assembly having at least one ball or preferably, a plurality of balls, and an inner and an outer race, said outer race having a thickened cross section.

### BRIEF DESCRIPTION OF THE DRAWING

FIG. 1 is a side elevational view of the working head portion of a dental handpiece, having the bearing construction according to the present invention.

FIG. 2 is a front elevational view of an embodiment of bearing assembly according to the present invention and useful in the dental handpiece of FIG. 1.

FIG. 3 is a front elevational view of an embodiment of bearing assembly according to the present invention and useful in the dental handpiece of FIG. 1.

FIG. 4 is a front elevational view of an embodiment of bearing assembly according to the present invention and useful in the dental handpiece of FIG. 1.

FIG. 5 is a front elevational view of an embodiment of bearing assembly according to the present invention and useful in the dental handpiece of FIG. 1.

FIG. 6 is a front elevational view of an embodiment of bearing assembly according to the present invention and useful in the dental handpiece of FIG. 1.

FIG. 7 is a front elevational view of an embodiment of bearing assembly according to the present invention and useful in the dental handpiece of FIG. 1.

FIG. 8 is a cross section of a bearing according to the present invention showing thickness dimensions in schematic.

FIG. 9 is a cross section of a bearing according to the present invention showing thickness dimensions in schematic.

FIG. 10 is a cross section of a bearing according to the present invention showing thickness dimensions in schematic.

FIG. 11 is a cross section of a bearing according to the present invention showing thickness dimensions in schematic.

### PREFERRED EMBODIMENTS FOR CARRYING OUT THE INVENTION

The handpiece selected for illustration is an air-driven handpiece 10 having a housing 11 with an internal chamber 12, and a pair of ball bearing assemblies 13 and 14 supporting a rotor assembly 15 having a shaft (bur-tube) 15a and a chuck 15b. Shaft 15a rotates within chamber 12 defined by the housing 11. The rotor includes any conventional driving means such as for example, an air-turbine 16 for rotatably driving rotor assembly 15.

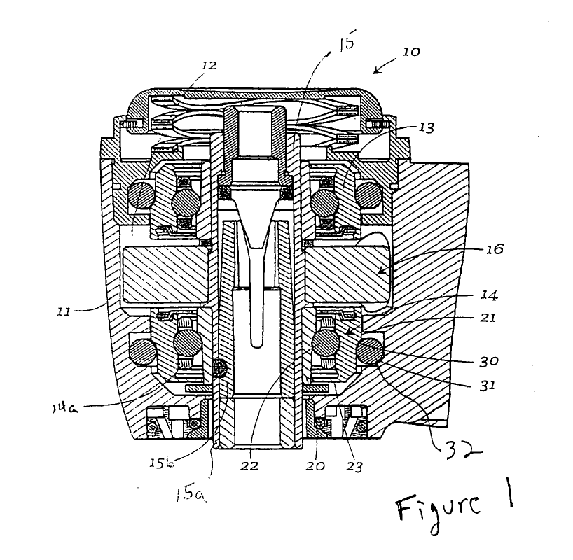

The turbine depicted in FIG. 1 is a radial-flow turbine which is driven by air, but of course, can be of any conventional design.

Bearing assemblies 13 and 14 will be discussed with respect to bearing assembly 14, it being understood that bearing assembly 13 may be of similar design and construction. Bearing assembly 14 has an inner race 20 and an outer race 21. As shown, bearing assembly 14 supports rotor assembly 15 in such a manner that rotor assembly 15 is supported in the desired location, but is also free to rotate when for example, driven by turbine 16. Bearing assembly 14 also includes ball bearing 22, and may include a pluarlity of balls or other rolling elements as may be conventional in the art. For simplicity, ball bearings are shown on the drawings. Such bearing assemblies as bearing assembly 14 are to such point, conventional in the art, and may also include according to the invention, a bearing shield 23 which is integral with the outer race.

According to the invention, outer race 21 is thicker than has heretofore been known in the art. For example, the outer race according to the invention and used in a dental handpiece of otherwise conventional size, may have an outer diameter of greater than about 0.25 inches, and preferably 0.28 inches or even greater. The inventive outer race 21 is approximately double in thickness over those bearings conventionally known in the art, and has as much as 0.03 inches greater in cross section as compared to previous dental handpieces.

By way of example, TABLE I shows a comparison of an exemplary dental handpiece bearing construction according to the invention, as compared to a commercially available dental handpiece, namely an XGT handpiece available from DENTSPLY International Inc. In this Table, the dual dimensions for outer race outer diameter represent dimensions above and below a shoulder 40 and it is understood that all dimensions are approximate and illustrative.

TABLE I

| | Conven- | | | | |
|---|---|---|---|---|---|
| Bearing | tional | Inventive | Inventive | Inventive | Inventive |
| feature | bearing | Example 1 | Example 2 | Example 3 | Example 4 |
| Inner | 0.125″ | 0.125″ | 0.125″ | 0.140″ | 0.140″ |
| race inner | | | | | |
| diameter | | | | | |
| Inner | 0.165″ | 0.165″ | 0.181″ | 0.181″ | 0.196″ |
| race outer | | | | | |
| diameter | | | | | |
| Outer | 0.220″ | 0.220″ | 0.235″ | 0.235″ | 0.250″ |
| race inner | | | | | |
| diameter | | | | | |
| Outer | 0.250″/ | 0.280″/ | 0.280″/ | 0.280″/ | 0.300″/ |
| race outer | 0.296″ | 0.296″ | 0.296″ | 0.296″ | 0.316″ |
| diameter | | | | | |

| | | Examples Of Inventive Bearing | | | |
|---|---|---|---|---|---|
| | | Version | Version | Version | Version |
| Characteristic | XGT | 1^{a} | 2^{b} | 3^{c} | 4^{d} |
| Inner-race | 0.125 | 0.125 | 0.125 | 0.140 | 0.140 |
| inner-diameter | | | | | |
| (ID) | | | | | |
| Inner-race | 0.020 | 0.020 | 0.028 | 0.020 | 0.028 |
| cross-section | | | | | |
| thickness | | | | | |
| Inner-race | 0.166 | 0.166 | 0.181 | 0.181 | 0.196 |
| out-diameter | | | | | |
| (OD) | | | | | |
| Outer-race | 0.220 | 0.220 | 0.235 | 0.235 | 0.250 |
| inner-diameter | | | | | |
| (ID) | | | | | |
| Outer-race | 0.15 | 0.038 | 0.030 | 0.030 | 0.033 |
| cross-section | | | | | |
| thickness* | | | | | |
| Outer-race OD, | 0.296 | 0.296 | 0.296 | 0.296 | 0.316 |
| above shoulder | | | | | |
| or flange | | | | | |
| Outer-race OD, | 0.250 | 0.280 | 0.280 | 0.280 | 0.300 |
| below shoulder | | | | | |
| or flange | | | | | |

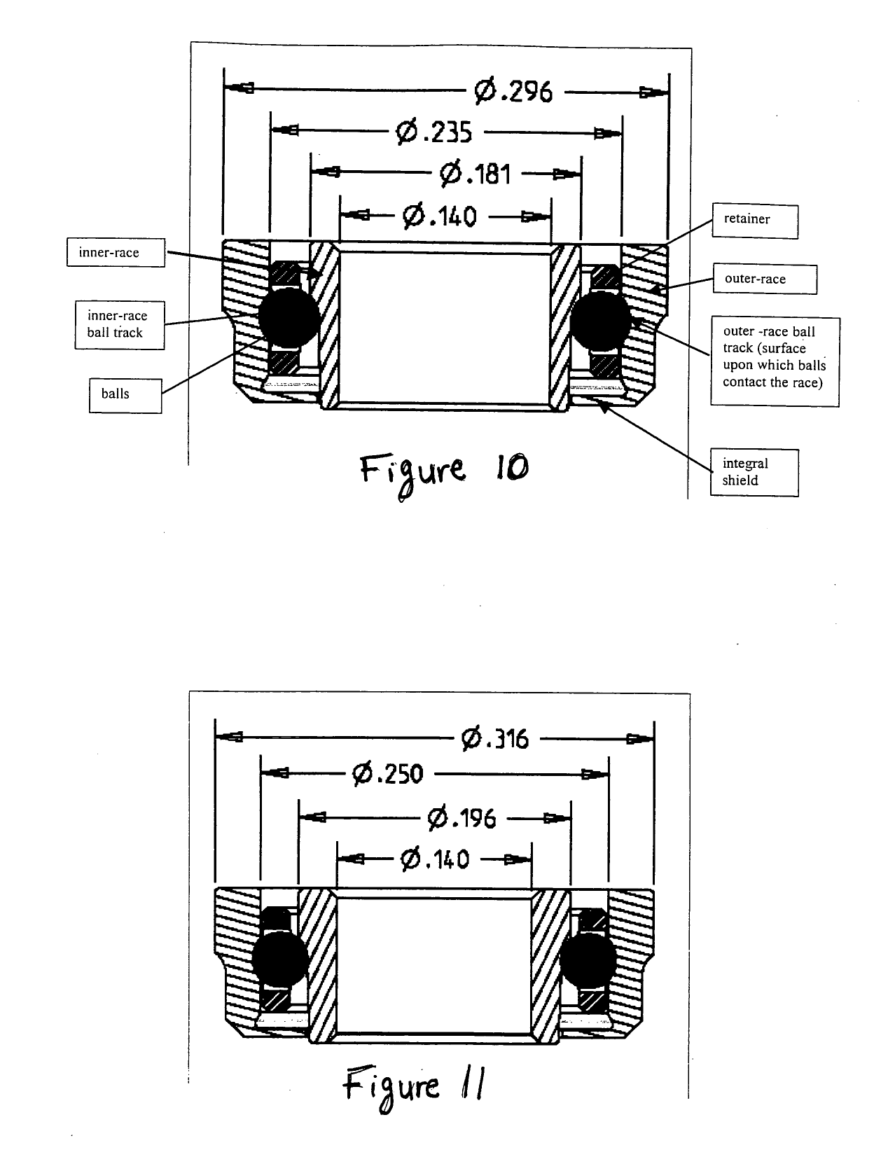

*Note:
The outer-race cross-section thickness is taken below the shoulder or flange, if there isa shoulder or flange feature
^{a}Drawing FIG. 8
^{b}Drawing FIG. 9
^{c}Drawing FIG. 10
^{d}Drawing FIG. 11

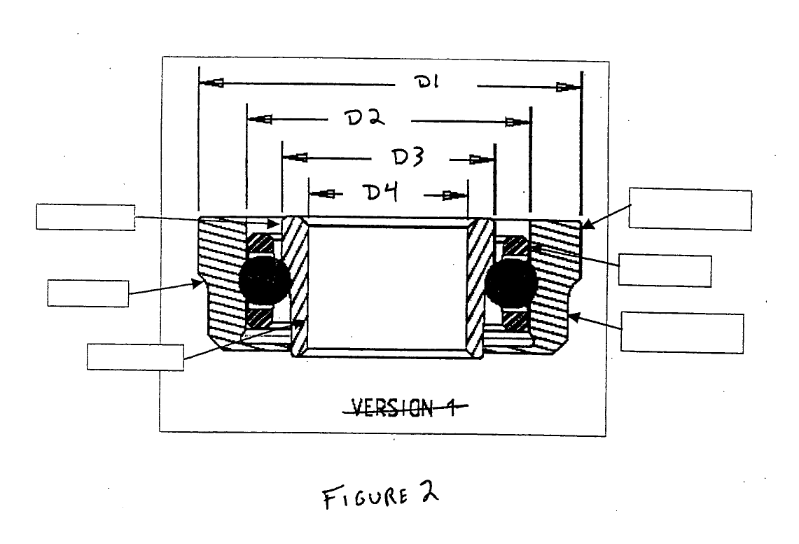

FIG. 2 shows a preferred embodiment and is listed as Inventive Example 1 in Table 1. The inner-race inner-diameter D4 is per industry conventional standard. Inner-race thickness (cross-section) D3 is also typical of conventional handpiece bearings. The outer-race inner-diameter D2 is also typical of standard handpiece bearings. According to the invention, the cross-section (thickness) and outer-diameter (OD) of the outer-race D1 is significantly greater than conventional bearings.

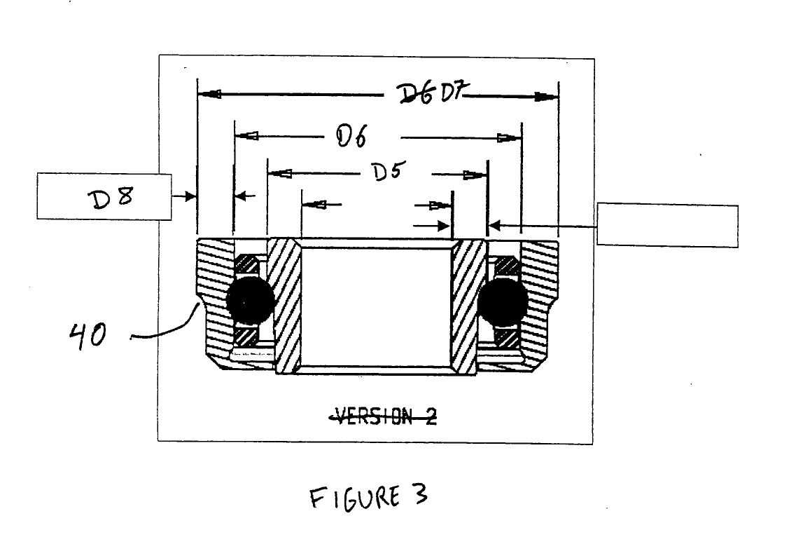

FIG. 3 shows Inventive Example 2. In this embodiment of the invention the inner-race outer-diameter D5 and the outer-race inner-diameter D6 are both increased. This has the effect of shifting the balls and ball tracks outward which will increase the load capacity and stiffness of the bearing, though with a penalty of higher ball speeds. The outer race cross-section thickness D8 is deceased relative to Inventive example 1 so the outer-race outer-diameter D7 remains the same as Inventive Example 1.

The outer-race also has a radiussed shoulder 30 to retain the suspension o-ring 31 (FIG. 1) in contrast to conventional bearings which either have a uniform outer-diameter or a flange with an abrupt stepped change in diameter.

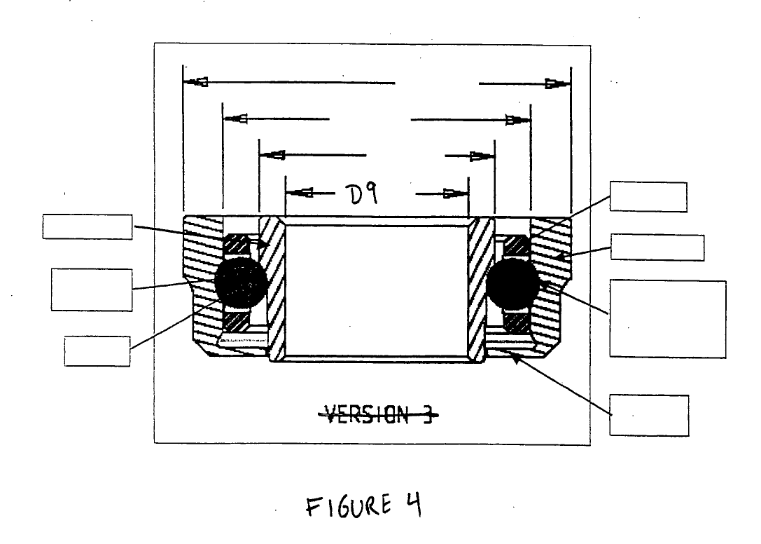

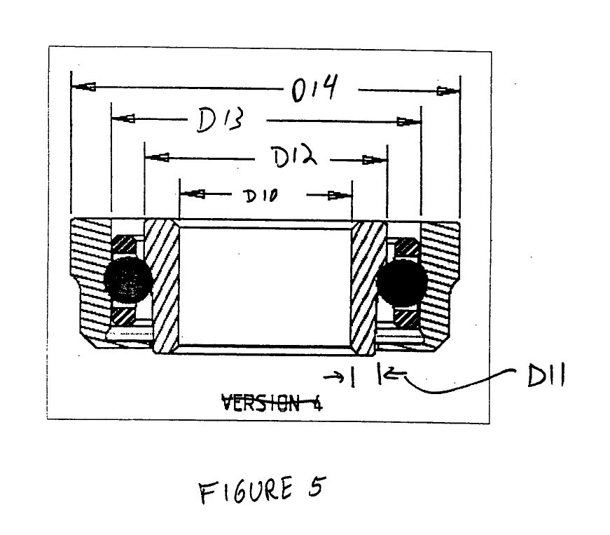

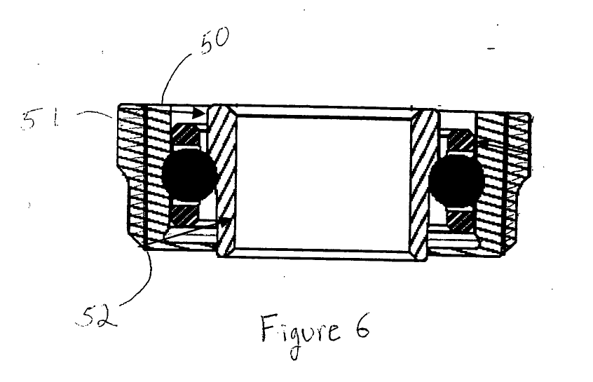

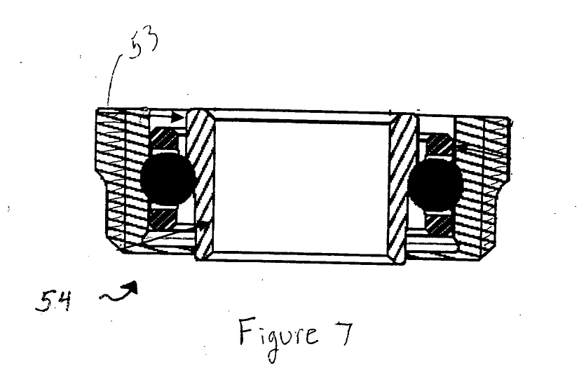

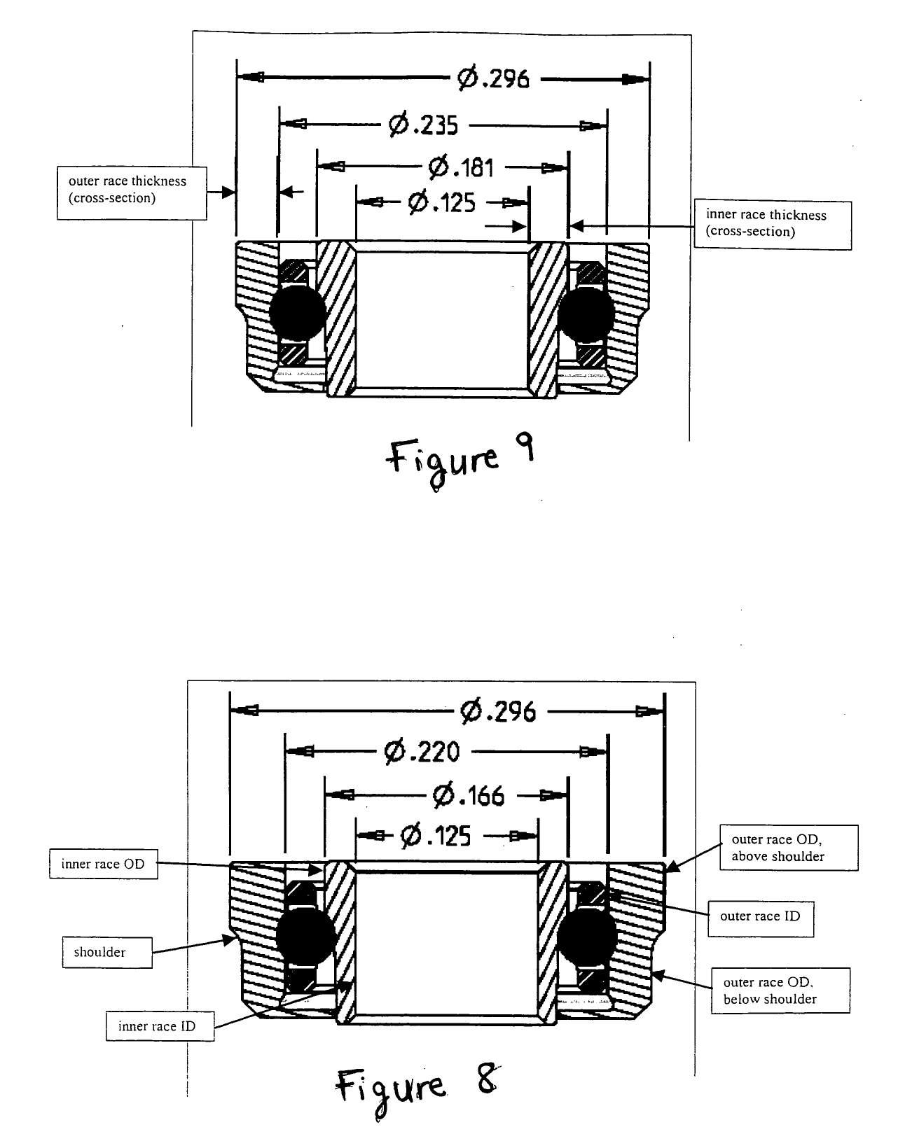

FIG. 4 shows an embodiment of Inventive Example 3 where the inner-race inner-diameter D9 is increased to a non-standard 0.140″ (it being understood that the symbol “means inches). This would allow increased bur-tube diameter, which is believed to improve stiffness of the bur-tube and performance of the chuck. However, this is at the expense of a reduced inner-race cross-section (thickness), which could reduce manufacturability and stiffness of the inner race. Relative to Inventive Example 1, this variant has a thinner outer-race cross-section in order to maintain the same outer-race outside diameter D1 as in Inventive Example 1.

FIG. 5 shows an embodiment of Inventive Example 4. In this embodiment inner-race inner-diameter D10 and cross-section D11 are both increased relative to standard bearings. As in Inventive Example 3, the increased inner-race inner-diameter D10 allows increased bur-tube diameter, which is believed to improve stiffness of the bur-tube and performance of the chuck. In contrast to Inventive Example 3, the inner-race outer-diameter D12 is increased in order to maintain the manufacturability and stiffness of the inner race.

Because the ball diameter has been maintained constant in Inventive Examples 1-4, the outer-race inner-diameter D13 has been increased commensurate with the increased inner-race outer-diameter D12. This shifts the balls and ball tracks outward which will increase the load capacity and stiffness of the bearing, though with a penalty of higher ball speeds.

In order to maintain the thicker outer-race cross-section of Inventive Example 1, the outer-race outer-diameter D14 is increased to 0.316. This provides the benefits of a stiffer bearing overall, but at the cost of increasing handpiece head diameter.

Also according to the present invention, the bearings as described may not have a flange, which in the previous conventional bearings served to transmit axial force from an elastomeric suspension “quad-ring”. Rather, the new bearing has a slight shoulder 30 upon which an elastomeric suspension o-ring 31 rests. O-ring 31 may be held within a groove 32. Axial force is still transferred from the o-ring 31 to the bearing outer race 21 to pre-load the bearing, but the geometry of the inventive bearing directs the vector of that force in-line with the contacts between ball 22 and ball grooves. It is believed that this directed force improves bearing performance under varying load conditions.

The races of the bearing 14 may be made from any conventional material useful for dental applications, such as for example, 440C “micro-melt” stainless steel.

As stated above, the outer race 21 of the inventive bearing 14 also includes an integral shield 23 on one side, in contrast to typical bearing practice in which one or both shields are separate rings welded or otherwise held in place. The shield on the opposite side of the new bearing is attached by any conventional means, such as spot-welding to the outer race 21 in a conventional manner.

The bearing materials of the invention may be any conventional material. For example, components such as bearing retainer 14a may be fabricated from materials such as Torlon, as currently used in many dental bearings. Of course, any retainer material or configuration could be used with the invention.

The balls 22 of the new bearing are preferably made of stainless steel, as currently used in almost all dental bearings. Of course, any allowable ball material could be used with the thick outer race.

Alternatively, increased mass of the outer race may be achieved by using a more dense material, without changing the cross section of the outer race. Further, two or more different materials 50, 51 (FIG. 6) may be used to fabricate the outer race. The innermost portion of the race would be of a material 50 (e.g. hardened steel or ceramic) selected to optimize bearing performance and life. The outermost portion 51 could be a material chosen for sound damping properties or greater density. Additionally, a thin layer 52 of adhesive, plastic, or elastomer between the two layers 50, 51 could further dampen sound transmission.

In an additional embodiment of the invention, some of the advantages of the invention my be provided by a sleeve 53 (FIG. 7) of any material surrounding the outer race of a conventional bearing 54 may be employed. This sleeve 53 could be pressed onto, into or otherwise affixed to the outer race 54 of a conventional bearing assembly. This sleeve 53 could be made of stainless steel, aluminum, brass or the like metal or other material.

The bearing could also incorporate other features:
A shield on one side which is integrated (formed with) the outer race.
A radiused flange on the outer race sized to mate with an elastomeric o-ring for suspension.
A bearing in which both the inner and outer race were thicker.
A bearing in which the inner race is comprised of multiple materials or sleeves, as describe above for the outer race.
Various materials for the races, balls, and ball retainer.
Various configurations of ball retainer.
Various configurations and geometry's of ball grooves.
Various sizes of balls.

The invention also proves easier to manufacture to high tolerances, and has less bearing distortion during manufacturing (during grinding, shield welding, and bearing press-fit assembly).

Prototype bearings have been assembled into prototype handpieces and testing shows an 8-12 dB reduction in noise.

It will also be appreciated that according to the invention, the dental handpiece bearing may be improved by varying either the thickness of the outer race, the inner race or both. As shown in TABLE I above, the inner race may also be made thicker. Combinations of thicker and thicker inner and outer races are within the scope of the invention. As will be appreciated, once one has determined not to be constrained by standard bearing size, various combination of bearing inner race ID, outer race OD, and ball track cross sections can be arrived at to optimize the overall design of the handpiece, according to the present invention.

While in the foregoing specification a detailed description of the invention has been set forth for the purpose of illustration, variations of the details herein given may be made by those skilled in the art without departing from the spirit and scope of the invention.

What is claimed is:

1. A dental handpiece of the type having a rotor supported by a ball bearing assembly, said ball bearing assembly having at least one ball and an inner and an outer race, wherein the improvement comprises a configuration selected from an outer race having a thickened cross section as compared to said inner race, an outer race having a thinner cross section as compared to said inner race, an inner race having a thickened cross section as compared to said outer race, an inner race having a thinner cross section as compared to said outer race, and combinations thereof.

2. A dental handpiece as in claim 1 wherein said inner race has an inner diameter of about 0.125 inches, said inner race has an outer diameter of about 0.165 inches, said outer race has an inner diameter of about 0.220 inches, and said outer race has an outer diameter equal to or greater than 0.280 inches.

3. A dental handpiece as in claim 1 wherein said inner race has an inner diameter of about 0.125 inches, said inner race has an outer diameter of about 0.181 inches, said outer race has an inner diameter of about 0.235 inches, and said outer race has an outer diameter equal to or greater than 0.280 inches.

4. A dental handpiece as in claim 1 wherein said inner race has an inner diameter approximately 0.140 inches or greater, said inner race has an outer diameter of about 0.181 inches, said outer race has an inner diameter of about 0.235 inches, and said outer race has an outer diameter equal to or greater than 0.280 inches.

5. A dental handpiece as in claim 1 wherein said inner race has an inner diameter greater than 0.125 inches, said inner race has an outer diameter of about 0.196 inches, said outer race has an inner diameter of about 0.250 inches, and said outer race has an outer diameter equal to or greater than 0.280 inches.

6. A dental handpiece comprising a rotor, one or more ball bearings supporting said rotor, said ball bearing(s) having a plurality of balls, an inner race, and an outer race, said outer race having a thickened cross section.

7. A dental handpiece as in claim 6, wherein said outer race has an outer diameter greater than about 0.25 inches.

8. A dental handpiece as in claim 7, wherein said outer race has an outer diameter of at least 0.28 inches

9. A method of fabricating a dental handpiece comprising the step of providing a bearing component of a density selected to provide sound dampening properties to the handpiece.

10. A method as in claim 9 wherein said component is a race.

11. A method of fabricating a dental handpiece comprising the step of providing a bearing component fabricated from at least two different materials.

12. A method as in claim 11 wherein at least one of said materials is selected to provide sound dampening characteristics to the dental handpiece and at least one of the other components is selected to provide improved bearing life characteristics.

13. A method as in claim 12 wherein at least one of said materials provides sound dampening by having a preselected density.

14. A method as in claim 12 wherein at least one of said materials is an adhesive.

15. A method as in claim 12 wherein at least one of said materials is selected from the group consisting of plastic and elastomeric materials.

16. A dental handpiece of the type having a rotor supported by a bearing, the improvement comprising adjusting the dimension of at least one of the bearing components using a sleeve thereover or therein.

17. A dental handpiece as in claim 16 wherein said sleeve is a metal.

18. A dental handpiece as in claim 17 wherein said metal is selected from the group consisting of steel, aluminum and brass.
